(19) United States
(12) Patent Application Publication
(10) Pub. No.: US 2005/0279438 A1
(43) Pub. Date: Dec. 22, 2005

(54) Motor vehicle tire

(76) Inventor: John Onracek, Pueblo, CO (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/872,845

(22) Filed: Jun. 21, 2004

(51) Int. Cl. B60C 5/22; B60C 11/01; B60C 13/00

(52) U.S. Cl. 152/209.11; 152/339.1; 152/209.16

(57) ABSTRACT

A tire for an automotive vehicle is described comprising both left and right exterior and interior sidewalls. The space between the respective sidewalls forms two additional tire chambers that are in fluid communication with the tire's primary chamber. Each of the exterior sidewalls include a downwardly facing portion with a treaded outside surface that is canted at an acute angle relative to the primary tread portion such that the treaded outside surfaces do not generally touch the road surface when the vehicle is traveling straight or turning at a low rate of speed. However, when turning at high speed or during hard cornering, one of the treaded surfaces of each depending on the direction of the turn contacts the road surface as the tire deforms and rolls thereby increasing the tire's foot print with the road and consequently the handling capability of the vehicle.

### FIELD OF THE INVENTION

This invention relates to tires for motor vehicles and, more particularly, to a tire having internal walls.

### BACKGROUND

Tires conventionally have an annular portion tread that is coupled with the circumferential edges of a wheel rim by a single pair of sidewalls that span between a respective circumferential edge of the tread and a corresponding edge of wheel rim. Accordingly, in combination with the out circumferential wall of the wheel rim, a tubeless airtight chamber is formed. The chamber is filled with pressurized air to give the tire shape and facilitate its intended use.

There are a number of competing factors involved in a tires design. Among the most important of these include: comfort; handling capability; and rolling resistance. Maximization of a conventional tire's performance for any one factor typically results in the degradation of performance in another area. For instance, by increasing the stiffness of the sidewall of a tire and/or pressurizing the tire more acts to reduce the tire's rolling resistance and consequently improve an associated vehicle's fuel efficiency. However, stiffening the sidewalls or increasing tire pressure acts to the detriment of a tire's cornering (or handling) capability and the suppleness of the associated vehicle's ride is also significantly reduced. In contrast, by making a tire wider to improve handling and cornering, the rolling resistance is increased substantially, thereby reducing the economy of the associated vehicle. Further, wider tires traditionally require wider rims, which increase the rolling weight of the vehicle and consequently reduce the rate of acceleration of an associated vehicle.

Several tires having multiple sidewalls walls have been proposed. However, most relate to tires having multiple chambers, such as U.S. Pat. Nos. 5,568,830; 5,479,976; and 4,280,546. The multiple chambers are provided primarily for safety purposes: first, the prevent a blow-out should the tire become punctured; and second, permitting a user of an associated vehicle to safely drive the vehicle for service or repair on a single chamber when one or more of the other chambers have been punctured. Realistically, modem tubeless tires are very safe, and blow-outs are exceedingly rare. Accordingly, the benefits of having multi-chambered tires are not cost effective when the extremely low magnitude of any safety risk is factored in. Further, because these tires were designed around safety considerations, they are not optimized for handling or efficiency characteristics.

U.S. Pat. No. 6,470,935 describes a tire having multiple sidewalls but wherein the multiple chambers are not pneumatically isolated. The tire is configured to primarily maximize efficiency, which unfortunately negatively impacts the tires handling and other performance characteristics. Because the additional sidewalls extends generally diagonally inwardly of the circumferential edges of an associated rim toward a common intersection on the treaded circumferential side of the tire, and because the diagonal sidewalls are relatively stout to facilitate supporting the vehicle at the general location of the intersection, the tire is very stiff to lateral forces and accordingly, its handling characteristics are compromised. Further, like traditional tires, the width of the rim must be increased to increase the width of the tires tread, thereby increasing the associated vehicle's rolling weight and hampering the vehicle's acceleration.

### SUMMARY OF THE INVENTION

One preferred embodiment comprises a tire. The tire includes (i) a generally convex left exterior sidewall, (ii) a generally convex right exterior sidewall, (iii) left and right interior generally vertical sidewalls and (iv) the primary annular tread portion. A first left sidewall portion of the left exterior sidewall extends outwardly and diagonally from a left annular tire bead to a left apex. A second left sidewall portion of the left exterior sidewall extends inwardly and diagonally from the left apex to an annular left edge of a substantially horizontal primary annular tread portion. The second left sidewall portion includes a treaded outer surface that generally forms an acute angle relative to the tread portion. A first right sidewall portion of the right exterior sidewall extends outwardly and diagonally from a right annular tire bead to a right apex. A second right sidewall portion of the right exterior sidewall extends inwardly and diagonally from the right apex to an annular right edge of the substantially horizontal primary annular tread portion. The second right sidewall portion includes a treaded outer surface and generally forming an acute angle relative to the tread portion. The interior sidewalls extend generally vertically from the left and right annular tire beads respectively. The tire rides primarily on the primary tread portion when coupled to a vehicle by way of a suitable rim and the vehicle is traveling substantially straight. The tire rides on both a portion of the primary tread portion and a portion of one of the left and right exterior sidewalls when the vehicle is turning one of left and right respectively.

Another preferred embodiment comprises an automotive wheel assembly. The wheel assembly including a standard rim for a tubeless tire with only two beaded edges, and a tubeless tire. The tubeless tire includes (i) left and right convex exterior walls, (ii) left and right interior walls, (iii) left and right convex exterior walls and (iv) a circumferential treaded portion. Each exterior wall extends outwardly and radially of respective left and right bead edges of the rim to a respective left and right apex, wherein the respective left and right apex is located horizontally a significant distance from the respective left and right bead edges. Each exterior wall further extends inwardly and radially from the respective left and right apex to an intersection with a respective left or right edge of the circumferential treaded portion. The respective intersection is generally radially vertically disposed of the respective left or right bead edge. The left and right interior wall extends generally radially and vertically from the respective left or right bead edge to the intersection with a respective left or right edge of a circumferential treaded portion. The circumferential treaded portion includes an outer surface having a tread formed thereon.

Yet another preferred embodiment comprises a tubeless tire for an automotive vehicle. The tubeless tire including (i) first and second sidewalls, (ii) a tread portion having an outer surface, (iii) third and fourth sidewalls with the proximal and distal end of each intersecting with the beaded edge and the distal end of one of the first and second sidewalls, and (iv) first and second sidewalls. Each of the first and second sidewalls extends from a beaded edge substantially vertically and radially to a distal end thereof. The first and second sidewalls are also horizontally spaced from each other. The tread portion is generally horizontal and spans between and integrates with the distal ends of the first and second sidewalls. The outer surface of the tread portion has a tread formed thereon. The third and fourth sidewalls are substantially convex and extend outwardly from the first and second sidewalls respectively. At least a downwardly facing portion of each of the third and fourth sidewalls has a tread formed thereon. The downwardly facing portion forms a generally acute angle relative to the tread portion.

### BRIEF DESCRIPTION OF THE DRAWINGS

FIG. 1 is an isometric view of one embodiment of the present invention with a cutaway portion.

FIG. 2 is a cross sectional view of one embodiment of the present invention showing a tire mounted to a rim.

FIG. 3 is a cross sectional front view of a prior art automotive tire illustrating the position of the tire when a vehicle to which it is attached is turning to the left at a high rate of speed.

FIG. 4 is a cross section front view of one embodiment of the present invention automotive illustrating the position of the tire when a vehicle to which it is attached is turning to the left at a high rate of speed.

### DETAILED DESCRIPTION

One embodiment of the present invention comprises an automotive tire having multiple sidewalls including on each side thereof an exterior sidewall that extends convexly from an associated generally interior sidewall. The combination of the interior sidewall and the convex exterior sidewall form a chamber that extends outwardly of the rim in the horizontal direction. The downwardly facing portion of the external sidewall also includes a tread formed on its outer surface.

Generally, the tread on the external sidewalls are not in contact with a road surface when the tire is mounted on a rim, which is mounted on a vehicle. Rather, when at rest and when an associated vehicle is traveling in a generally straight path, only a center treaded portion of the tire located between respective left and right interior sidewalls is in contact with the road surface. However, when the vehicle is turned sharply or at a relatively high rate of speed, the tire rolls and depending on the direction of the turn, one of the downwardly facing portions of the exterior sidewalls contacts the road surface providing for much greater traction and facilitating higher cornering speeds.

Advantageously, when driving normally, the rolling resistance of the tire is reduced for greater fuel economy similar to a thin tire that has a small footprint, but when turning at speed or sharply, the tire exhibits the handling characteristics of a wide tire with a larger footprint. Additionally, because the interior sidewalls in combination with the center treaded portion form a primary chamber having a volume similar to that of a traditional prior art tire and because the additional chambers formed by the addition of the exterior sidewalls are in pneumatic communication with the primary chamber, the ride is relatively supple, especially when compared to prior art tires having interior sidewalls that separate the tire into pneumatically isolated chambers or prior art tires that utilize the interior sidewalls to help support the tire.

The advantages of the embodiments described herein above and below along with the particular configuration of the described embodiment(s) of the invention are not conclusive or even exhaustive but rather merely representative of the best mode of using the invention. Rather, numerous variations and other embodiments have been contemplated that read upon the appended claims and are, accordingly, intended to be within the scope of the invention.

### Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The term “Apex” as used herein refers generally to a point or location furthest from a base location(s). For instance, concerning the convex external sidewalls, the leftmost or rightmost location of the left and right external sidewalls respectively is the “apex” of the sidewall.

### One Embodiment of the Automotive Tire

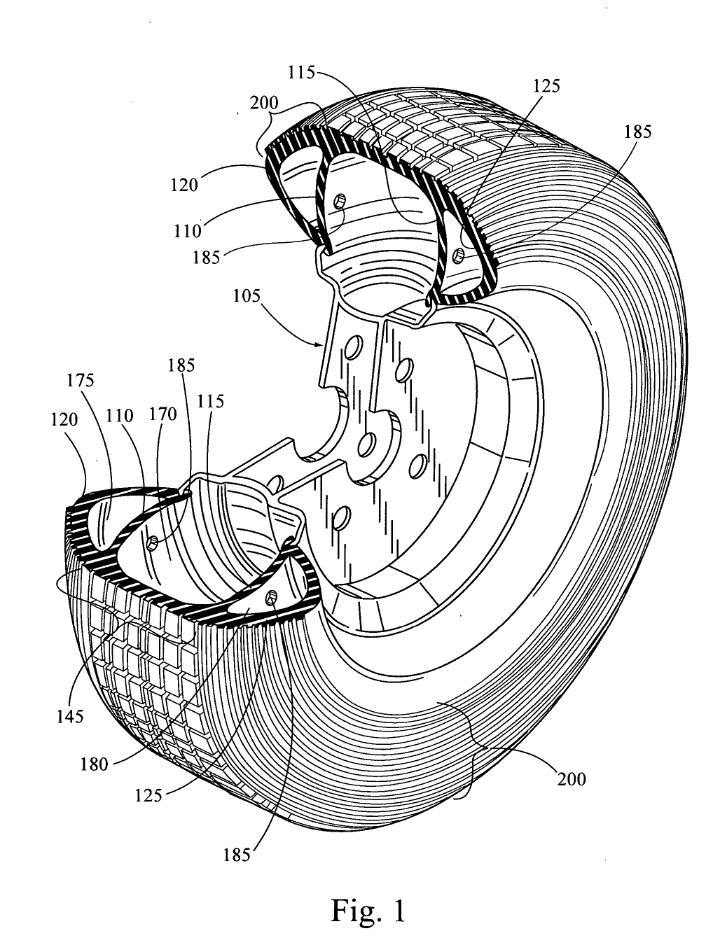

One embodiment of the present invention comprises a tire 100 with or without an associated rim 105 having at least two interior sidewalls 110 & 115 and two exterior sidewalls 120 & 125 as illustrated in FIGS. 1-4. The tire typically includes (i) a generally horizontal (when its preferred position of use) annular primary tread portion 130 that extends circumferentially around the tire, (ii) left and right generally vertical interior sidewalls 110 & 115 that extend from a respective left or right annular tire bead 135 & 140 to a distal end that intersects and integrates with the primary tread portion, and (iii) left and right generally convex exterior sidewalls 120 & 125 that span between a proximal end at the annular tire bead and a distal end that intersects and integrates with the primary tread portion and the respective left or right interior sidewall. Except for the incorporation of the additional sidewalls, the tire 100 of the one embodiment is constructed in a manner and with materials similar to that used for conventional tires. Accordingly, a person of ordinary skill in the art would be capable of constructing a tire of the one embodiment without undue experimentation.

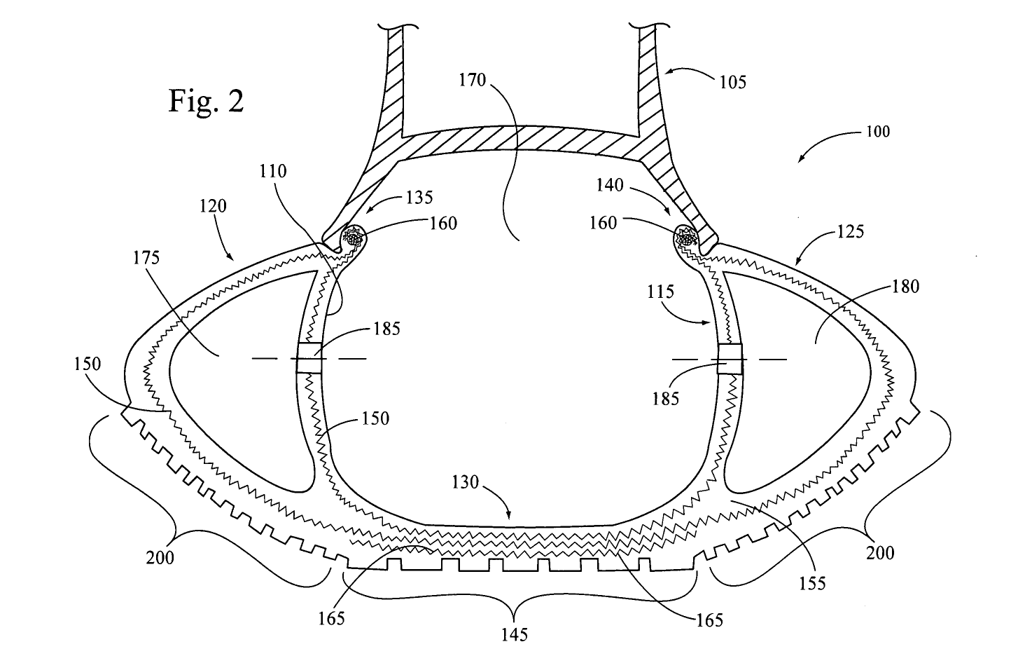

Referring primarily to FIGS. 1 and 2, the annular primary tread portion 130 includes an outer generally horizontal surface having a suitable treaded outer surface 145 formed thereon. The width of the tread portion varies depending on the size of the tire but basically has a width similar to that of a conventional tire that would mount on a similar rim. In other words, the width of the primary tread portion is typically the width of a suitable rim 105 or slightly wider.

As is best shown in FIG. 2, the primary tread portion typically includes one or more plies of reinforcing cord 150 or fabric that are sandwiched between and in an elastomeric compound 155, such as carbon-filled synthetic rubber (only a single representative ply is illustrated for clarity). In radial versions of the one embodiment, the reinforcing cord plies extend widthwise across the primary tread portion 130 and radially across one of the left interior and exterior sidewalls 110 & 120 and one of the right exterior and interior sidewalls 115 & 125 to and around the annular bead 160 bundle that forms the core of the annular bead 135 & 140. The reinforcing cord and/or fabric plies can comprise any suitable material, such as, but not limited to, polyester.

The elastomeric compound of the primary tread portion 130 can vary substantially as well. As is well known in the art, different compounds are utilized to form the tread on the outer surface depending on the desired characteristics of the tire. For instance, tread comprised of softer tackier elastomers is utilized on tires optimized for handling while harder elastomers are used on tires optimized for tread life and to minimize rolling resistance. The actual compound used in the tread of the one embodiment can vary depending on the design criteria relating to a particular tire.

Also as shown in FIG. 2, the one embodiment of the tire can include one or more reinforcing belts 165 (only a single belt is illustrated for clarity). The belts typically comprise one or more plies of reinforcing material sandwiched between elastomeric compound 155 that can be essentially the same material as is used in the reinforcing cord plies 150 or more commonly another material. The belts are most commonly comprised of a fabric of steel wire or aramid fibers. The primary purpose of the belts is to protect the tire from punctures, such as from glass, nails or other debris that a vehicle may rollover on the road. The weft and warp directions of the belt's fabric can vary substantially depending on the desired characteristics of the tire. For instance, in some variations the fibers or wires in the warp direction may extend circumferentially with the fibers or wires in the weft direction extending widthwise across the primary tread portion. In other variations, the weft and warp directions may be biased relative to the circumferential and widthwise directions of the tire.

The left and right interior sidewalls 110 & 115 are also the best illustrated in FIG. 2. Like the primary tread portion 130, the interior sidewalls comprise reinforcing cord plies 150 sandwiched between and encapsulated in elastomeric compound 155. As described above, the reinforcing cord plies are the same plies that extend in and across the primary tread portion. It is to be appreciated, however, that the particular composition of the elastomeric compound utilized in the interior sidewalls may differ from the compound used in sections of the primary tread portion. Whereas, the tread 145 on the outer surface of the primary tread portion is optimized for characteristics relating to its rotation relative to and contact with the road surface, the compound in the interior sidewalls, as well as the exterior sidewalls 120 & 125, is optimized primarily for strength and flexibility.

The proximal ends of the left and right interior sidewalls 110 & 115 include respective left and right tire beads 135 & 140. Typically, the tire beads comprise cord bundles 160 that extend circumferentially around the respective proximal end. One end of each of the reinforcing plies 150 is typically wrapped around a cord bundle. As is well-known in the art, the beads are configured to interface with a corresponding circumferential bead on the rim and for an airtight seal. Accordingly, the outer circumferential surface of the rim in combination with the sidewalls of the tire and the interior surface of the primary tread portion form one or more chambers 170, 175 & 180 to contain a pressurized gas.

Along the generally vertically extending portion of the left and right interior sidewalls 110 & 115 in the one embodiment, one or more openings 185 are formed through which pressurized gas can freely move between the chambers formed by the respective left and right exterior and interior sidewalls and the primary chamber 170. The distal end of each interior sidewall intersects with and integrates with the primary tread portion such that the primary tread portion, the interior sidewalls, as well as, the exterior sidewalls 120 & 125 form a unitary tire.

The primary function of the left and right interior sidewalls 110 & 115 in the one embodiment is to hold the tire 100 in its proper shape. As can be appreciated, if the interior sidewalls were eliminated, the tire pressure would cause the exterior sidewalls 120 & 125 to straighten and exhibit a more vertical and less convex cross-section. Accordingly, the left and right interior sidewalls assume a generally vertical orientation, although they may be slightly convex, when the tire 100 is mounted on a rim 105 and pressurized. Because the left and right interior sidewalls are not exposed to rocks, curbs and other hazards and because the interior sidewalls do not act to support the primary tread portion, the interior sidewalls need not be as thick or stout as similarly disposed exterior sidewalls on a conventional tire, thereby minimizing the stiffening effect related to adding additional sidewalls to a tire.

Still referring primarily to FIG. 2, the left and right exterior sidewalls 120 & 125 are best illustrated. They are of generally similar construction as the interior sidewalls 110 & 115, although they are generally thicker and include a greater number of reinforcing plies 150 to provide puncture resistance to hazards, such as rocks and curbs. While a thicker exterior sidewall combined with a second interior sidewall on both the left and right side of a tire would typically result in an overly stiff tire that would cause ride and comfort characteristics to suffer, the ride characteristics of the one embodiment tire do not suffer when compared to a conventional tire as the exterior sidewalls are significantly convex, which permits them to flex appreciably and freely when subject to lateral and vertical loads.

The proximal end of the exterior sidewalls comprises the aforementioned left and right tire beads 135 & 140. Like the reinforcing plies of the interior sidewalls 110 & 115, the reinforcing plies 150 of the exterior sidewalls also terminate by wrapping around the annular bead bundles 160 of each tire bead 135 & 140. From the proximal end and the intersection with the rim 105, each exterior sidewall 120 & 125 extends downwardly and outwardly to either the left or the right at an acute angle relative to vertical to a left or right horizontal apex 190 & 195. From the horizontal apex, each exterior sidewall extends downwardly and inwardly at an acute angle relative to horizontal until intersecting with both the respective interior sidewall and the respective edge of the primary tread portion 130.

Of particular note concerning the outside surface 200 of each of the downwardly and inwardly extending portions of the exterior sidewalls 120 & 125 is that they have a tread formed thereon. As best illustrated in FIG. 2, these treaded outside surfaces 200 are not normally and contact with the road surface. Rather, as shown in FIG. 4, they come into contact with the road surface only when an associated vehicle is turning or cornering and a relatively high rate of speed. Specifically, the tire 100 deforms in response to the centrifugal forces acting upon both the vehicle and the tire to place the respective outside surface 200 and contact with the road. As can be appreciated, the greater contact area during hard cornering increases the tire's grip on the road surface and thereby improves the handling characteristics of the associated vehicle.

Typically, the elastomeric compound 155 utilized on the treaded outside surfaces 200 of the downwardly and inwardly extending portions of the exterior sidewalls is different from that utilized on the outwardly and downwardly extending upper portions of the exterior sidewalls as it is optimized for occasional contact with the road surface. Further, the compound utilized on the treaded outside surfaces of the exterior sidewalls need not be the same as the compound utilized on the treaded outside surface 145 of the primary treaded portion 130. For instance, in certain variations of the one embodiment, the compound used on the outside surfaces of the exterior sidewalls can be softer and stickier than the compound used on the tread of the primary tread portion, which, for example, could be optimized to minimize tread wear. With such a combination, a tire can be produced that offers superior cornering and handling characteristics while providing a higher life than conventional performance tires.

This further appreciated, that the pattern of the treaded surfaces 200 & 145 on both the exterior sidewalls 120 & 125 and the primary tread portion 130 can be different from each other. For instance, the tread 145 of the primary tread portion can be optimized for handling in rain or snow, while the tread 200 on the outer surface of the exterior sidewalls may be optimized for cornering. Numerous variations in tread pattern and tread compound would be obvious to someone of ordinary skill in the art with the benefit of this disclosure.

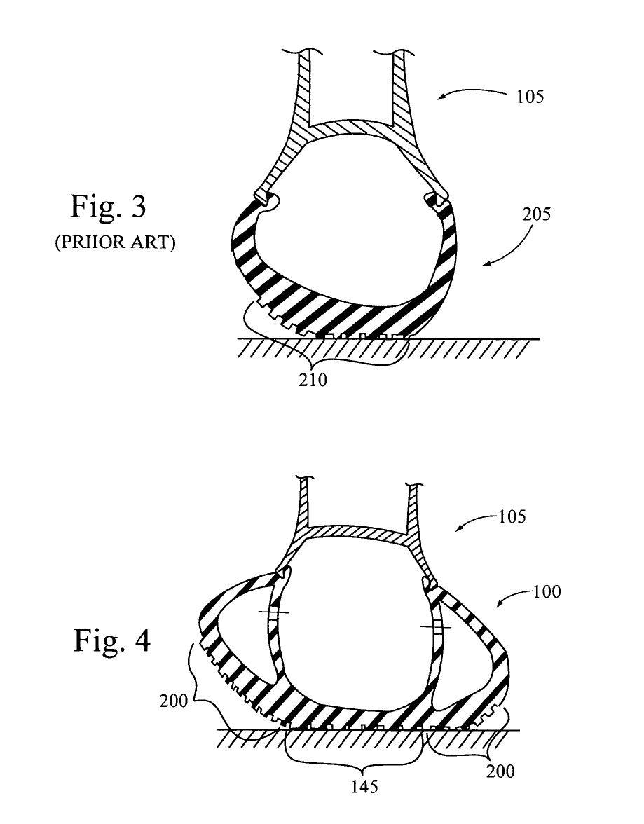

If referring briefly to FIGS. 3 and 4, the operation of the one embodiment tire 100 will be briefly described relative to a conventional tire 205. When turning hard or cornering and a high rate of speed in a vehicle with conventional tires, a portion of the tire's treaded surface 210 loses contact with the road surface as the tire rolls in response to cornering forces as illustrated in FIG. 3. The reduced footprint of each tire on the ground surface reduces the cornering ability of the associated vehicle. In contrast, as shown in FIG. 4, the amount of tread surface 145 & 200 in contact with the road surface increases when the one embodiment tire 100 is used, thereby increasing the cornering capability of the associated vehicle. However, when the vehicle is traveling straight, the treaded portions of the exterior sidewalls 120 & 125 are not in contact with the road surface, and accordingly, the footprint of each tire is comparable to that of a conventional tire that would fit on a similarly-sized rim. In short, the tire of the one embodiment of the present invention provides rolling resistance characteristics similar to that of a conventional tire fitting on a similar-sized rim, but also provides cornering and handling characteristics that would typically be associated with a much wider tire on a much wider rim. As a further advantage of the one embodiment tire is that it can provide a superior ride to conventional tire that would fit on a similarly-sized rim largely because of its expanded volume as a result largely of the left and right chambers 175 & 180 and the ability of the pressurized gas contained in the chambers to move freely through the openings 185 in the interior sidewalls 110 & 115 in response to forces acting on the tire.

### Other Embodiments and Other Variations

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

For example, in certain variations and other embodiments the chambers can be isolated from each other such that the gas pressures in the primary chamber may be different from that in the left and right chambers. Such a pressure differential between chambers may be desirable and tuning in alternative embodiment tire to particular set of operational characteristics. In other variations and embodiments, the interior sidewalls can be replaced with vertically extending cords or an open webbing, such that the tire effectively comprises a single chamber.

1. A tire comprising:
a generally convex left exterior sidewall, a first left sidewall portion of the left exterior sidewall extending outwardly and diagonally from a left annular tire bead to a left apex and a second left sidewall portion of the left exterior sidewall extending inwardly and diagonally from the left apex to an annular left edge of a substantially horizontal primary annular tread portion, the second left sidewall portion including a treaded outer surface and generally forming an acute angle relative to the tread portion;
a generally convex right exterior sidewall, a first right sidewall portion of the right exterior sidewall extending outwardly and diagonally from a right annular tire bead to a right apex and a second right sidewall portion of the right exterior sidewall extending inwardly and diagonally from the right apex to an annular right edge of the substantially horizontal primary annular tread portion, the second right sidewall portion including a treaded outer surface and generally forming an acute angle relative to the tread portion;
left and right interior generally vertical sidewalls, the interior sidewalls extending generally vertically from the left and right annular tire beads respectively; and
the primary annular tread portion;
wherein the tire rides primarily on the primary tread portion when coupled to a vehicle by way of a suitable rim and the vehicle is traveling substantially straight, and the tire rides on both a portion of the primary tread portion and a portion of one of the left and right exterior sidewalls when the vehicle is turning one of left and right respectively.

2. The tire of claim 1, wherein the left exterior sidewall and the left interior sidewall form a left chamber.

3. The tire of claim 2, wherein the right exterior sidewall and the right interior side wall form a right chamber.

4. The tire of claim 3, wherein a primary chamber is formed when the tire is mounted to a suitable rim, the primary chamber comprising the left and right interior sidewalls, the primary annular tread portion and an annular outwardly facing surface of the rim.

5. The tire of claim 4, wherein the left and right chambers are in pneumatic communication with the primary chamber.

6. The tire of claim 1, wherein a tread pattern on the second right sidewall portion and the second left sidewall portion differ from a tread pattern on the primary tread portion.

7. The tire of claim 1, wherein the tire is tubeless.

8. The tire of claim 1, wherein the tire is a radial tire.

9. The tire of claim 1, wherein the primary tread portion includes one or more belts.

10. The tire of claim 1, wherein the rubber compound comprising the treaded surface of the second right sidewall portion and the second left sidewall portion differ from a rubber compound comprising a treaded surface of the primary treaded portion.

11. An automotive wheel assembly comprising:
a standard rim for a tubeless tire having only two beaded edges; and
a tubeless tire, the tubeless tire including
(i) left and right convex exterior walls, each wall extending outwardly and radially of respective left and right bead edges of the rim to a respective left and right apex, wherein the respective left and right apex is located horizontally a significant distance from the respective left and right bead edges, each exterior wall further extending inwardly and radially from the respective left and right apex to an intersection with a respective left or right edge of a circumferential treaded portion, the respective intersection being generally radially vertically disposed of the respective left or right bead edge,
(ii) left and right interior walls, the left and right interior wall extending generally radially and vertically from the respective left or right bead edge to the intersection with a respective left or right edge of a circumferential treaded portion, and
(iii) the circumferential treaded portion, the circumferential treaded portion including an outer surface having a tread formed thereon.

12. The wheel assembly of claim 11, wherein at least a portion of an outer surface of the left exterior sidewall includes a tread formed thereon.

13. The wheel assembly of claim 12, wherein at least a portion of an outer surface of the right exterior sidewall includes a tread formed thereon.

14. The wheel assembly of claim 11, wherein the rim is comprised of aluminum alloy.

15. The wheel assembly of claim 11, wherein the rim is comprised of steel.

16. The wheel assembly of claim 11, wherein at least one of the left and right interior sidewalls include one or more openings extending therethrough.

17. A tubeless tire for an automotive vehicle, the tubeless tire comprising:
first and second sidewalls, each extending from a beaded edge substantially vertically and radially to a distal end thereof, the first and second sidewalls being horizontally spaced from each other;
a tread portion having an outer surface, the tread portion being generally horizontal and spanning between and integrating with the distal ends of the first and second sidewalls, the outer surface of the tread portion having a tread formed thereon; and
third and fourth sidewalls with the proximal and distal end of each intersecting with the beaded edge and the distal end of one of the first and second sidewalls, the third and fourth sidewalls being substantially convex and extending outwardly from the first and second sidewalls respectively, at least a downwardly facing portion of each of the third and fourth sidewalls having a tread formed thereon, the downwardly facing portion forming a generally acute angle relative to the tread portion.

18. The tubeless tire of claim 17, wherein the tread on each downwardly facing portion of the third and fourth sidewalls is substantially not in contact with a road surface when the tire is mounted on a rim, pressurized and at rest with the outer surface of the tread portion being in substantial contact with the surface of the road.

19. A combination comprising two or more tubeless tires of claim 17, two or more automotive wheel rims having the two or more tubeless tires mounted and pressurized thereon, and an automotive vehicle having the two or more rims mounted thereon.

20. The combination of claim 19, wherein when the tread portions of the two or more tires are in contact with a road surface at one of rest or rolling in a substantially straight path, the tread on each of the downwardly facing portions of the two or more tires are not in contact with the road surface.
